(19) United States
(12) Patent Application Publication
(10) Pub. No.: US 2024/0143580 A1
(43) Pub. Date: May 2, 2024

(54) METHOD AND SYSTEM FOR DYNAMIC QUERY PARAMETERS THROUGH INTERACTIVE USER INTERFACE CONTROLS

(71) Applicant: RAKUTEN MOBILE, INC., Tokyo (JP)

(72) Inventors: Dewa SISWANTO, Tokyo (JP); Murugavel NATARAJAN, Bengaluru (IN); Vidyasagar MISHRA, Indore (IN)

(73) Assignee: RAKUTEN MOBILE, INC., Tokyo (JP)

(21) Appl. No.: 17/770,800

(22) PCT Filed: Feb. 3, 2022
(86) PCT No.: PCT/US2022/015021

§ 371 Date: Aug. 10, 2023

(51) Int. Cl. G06F 16/242; G06F 16/248

(52) U.S. Cl. CPC G06F 16/2423; G06F 16/248

(57) ABSTRACT

A method is provided. The method includes providing a user interface (UI), receiving a user input to the UI to generate a query, generating the query based on the user input, wherein the query includes at least one static parameter and at least one dynamic parameter, retrieving first data from a database based on the query and the at least one dynamic parameter, and generating a first visualization of the retrieved first data.

### BACKGROUND

### 1. Field

The disclosure relates generally to a method and system that include dynamic queries using dynamic parameters.

### 2. Description of Related Art

Multiple applications may be hosted and deployed in a particular ecosystem, such as a cloud platform for an enterprise or business. Typically, each application in the platform has its own mechanism for presenting reports of data generated or processed by the application or to configure a reporting template or dashboard for viewing the data.

For creating a visualization of data from a database, a specific query may be required for fetching the data from the database. However, this requires the user creating the query to have sufficient knowledge on the dataset as well as sufficient knowledge on the query language. Furthermore, the query written may be static, which cannot be built upon or changed dynamically while the user interacts with the visualization (i.e., to change the visualization of the data, the user re-writes the query). This results in multiple, independent queries being defined and generated, as well as excess data retrieval being performed.

### SUMMARY

In accordance with an aspect of the disclosure, a method may include providing a user interface (UI), receiving a user input to the UI to generate a query, generating the query based on the user input, wherein the query includes at least one static parameter and at least one dynamic parameter, retrieving first data from a database based on the query and the at least one dynamic parameter, and generating a first visualization of the retrieved first data.

In accordance with an aspect of the disclosure, a system may include a memory storing instructions, and a processor configured to execute the instructions to provide a UI, receive a user input to the UI to generate a query, generate the query based on the user input, wherein the query includes at least one static parameter and at least one dynamic parameter, retrieve first data from a database based on the query, and generate a first visualization of the retrieved first data.

In accordance with an aspect of the disclosure, a non-transitory computer readable storage medium may be connected to one or more processors and may store instructions that, when executed, cause the one or more processor to provide a UI, receive a user input to the UI to generate a query, generate the query based on the user input, wherein the query includes at least one static parameter and at least one dynamic parameter, retrieve first data from a database based on the query, and generate a first visualization of the retrieved first data.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of a system architecture according to one or more embodiments;

FIG. 2 is a block diagram of the centralized data management system according to an embodiment;

FIGS. 3A, 3B and 3C are diagrams illustration a system operation with a dynamic parameter, according to an embodiment;

FIGS. 4A, 4B, 4C, 4D, 4E, 4F, 4G, 4H, 4I, 4J, 4K, 4L, 4M, 4N, 4O, 4P, 4Q, 4R, 4S and 4T are diagrams of a user interface (UI) for generating queries and data visualizations, according to an embodiment;

FIG. 5 is a flowchart of a method of retrieving data, according to an embodiment; and

FIG. 6 is a diagram of components of a device according to an embodiment.

### DETAILED DESCRIPTION

The following detailed description of example embodiments refers to the accompanying drawings. The same reference numbers in different drawings may identify the same or similar elements.

According to one or more example embodiments, data reporting and dashboarding capabilities are abstracted from each application in an ecosystem or platform and centralized in the data management and reporting system. As a result, developers of the applications need not create a reporting and dashboarding capability for each application or an individual data handling flow for each reporting and dashboarding use case. Instead, each application exposes its output or presentation data to a storage of (or accessible by) the centralized system (e.g., a data lake). Furthermore, the centralized data management system may include a dataset engine to build or generate a data cube or dataset from the exposed data to be processed for data visualization, reporting, or dashboarding (hereinafter “data management”). Thus, data management is standardized across all applications connected to the centralized data management system, with a standard process or workflow, thereby enhancing a user experience and platform usability and simplifying application development.

The centralized data management and reporting system (hereinafter “centralized data management system”) according to one or more example embodiments may provide at least one interface through which a user can create or configure data visualizations, report templates, and/or data dashboards from the data exposed by the applications in the ecosystem (e.g., cloud platform).

The centralized data management system according to one or more example embodiments may provide a user interface (UI) with which a user may interact. A user may define a query for accessing and visualizing data stored in a database. The centralized data management system may provide interactive elements on the UI to assist a user in defining a query. Therefore, a user of the centralized data management system does not need to have prior knowledge of specific query language to generate a query.

The centralized data management system according to one or more example embodiments may provide a query building interface in which a user may include a dynamic parameter. The query may include static parameters and at least one dynamic parameter. When the query with the dynamic parameter is built and executed, the centralized data management system retrieves the relevant data according to the query and presents a data visualization based on the retrieved data. The user, with the UI, may change the dynamic parameter of the query without generating a new query. When the centralized data management system executes the changed query, the centralized data management system presents a new data visualization based on the data for the changed query. Thus, the centralized data management system does not require multiple queries to be generated for each data retrieval requested by a user. Furthermore, the amount of data retrieved and the number of times data retrieval is performed may be reduced.

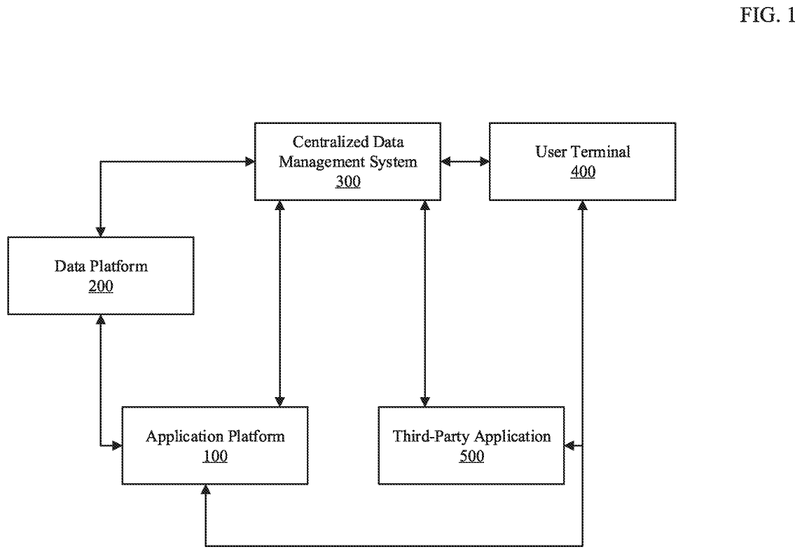

FIG. 1 is a diagram of a system architecture according to one or more embodiments. Referring to FIG. 1, the system architecture includes an application platform 100, a data platform 200, a centralized data management system 300 according to an embodiment, a user terminal 400, and a third-party application 500.

The application platform 100 is a platform that hosts and/or deploys one or more applications. The application platform 100 may be a cloud platform including one or more servers in which the one or more applications are deployed. For example, the application platform 100 may be a cloud platform for a particular business or enterprise in which applications are deployed for use by employees and/or customers of the business (e.g., applications for day-to-day operations of the business, processing or inputting sales information, communicating with customers, troubleshooting, etc.). The applications in the application platform 100 are configured to output or expose data that may be used for analysis and/or presentation (e.g., visualization, dashboarding, etc.). In some embodiments, the applications are telecommunication software applications.

The data platform 200 is communicatively connected or coupled to the application platform 100 and receives the data output by the one or more applications. The data platform 200 is a storage repository (e.g., one or more servers, data lake, data warehouse, etc.) that stores the data received from the application platform 100. By way of example, the data platform 200 may be a data lake that receives and stores data output from the application platform 100 in its native form. Further, the data platform 200 may store datasets corresponding to the applications in the application platform 100.

The centralized data management system 300 is communicatively connected or coupled to the data platform 200, and is configured to create, edit, and output data visualizations from the data stored in the data platform 200. The centralized data management system 300 may also be communicatively connected or coupled to the application platform 100, and configured to output data visualizations to one or more applications in the application platform 100. The centralized data management system 300 includes one or more computing devices (e.g., servers) having memory for storing executable instructions and at least one processor for executing those instructions to perform the functions (described in further detail below) of the centralized data management system 300.

The user terminal 400 is a user device through which a user accesses the centralized data management system 300 directly or indirectly via an application, namely, an application in the application platform 100 or the third-party application 500. Through the user terminal 400, an end user may generate, configure, and/or view a data visualization of the data management system, as will be set forth in further detail below.

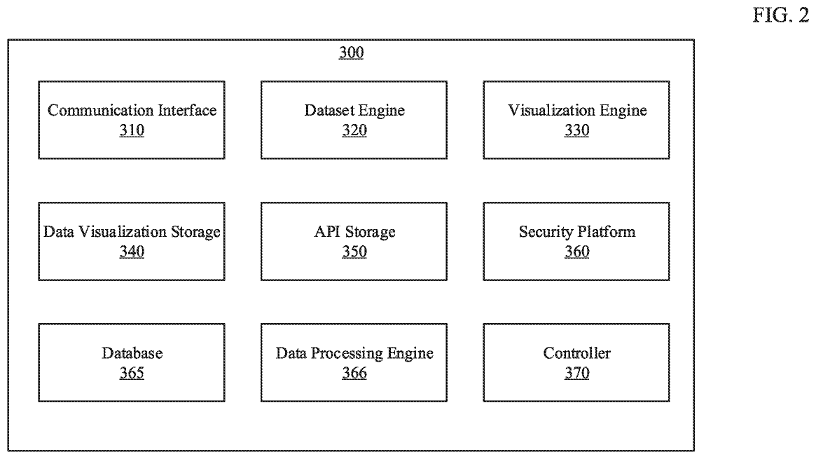

FIG. 2 is a block diagram of the centralized data management system 300 according to an embodiment. Referring to FIG. 2, the centralized data management system 300 includes a communication interface 310, a dataset engine 320, a visualization engine 330, a data visualization storage 340, an application programming interface (API) storage 350, a security platform 360, a database 365, a data processing engine 366, and a controller 370. In some embodiments, the data visualization storage 340, the API storage 350, the security platform 360, and/or the database 365 are external to the centralized data management system 300.

The communication interface 310 is configured to communicatively connect or couple to the data platform 200, the application platform 100, and/or one or more user terminals 400 via a wired and/or wireless connection. The communication interface 310 may also connect to one or more third-party applications 500 in some embodiments. For example, the communication interface 310 may be directly connected to the data platform 200, the application platform 100, the third-party application 500, and/or the one or more user terminals 400 via a cable (e.g., universal serial bus (USB), coaxial, etc.). By way of another example, the communication interface 310 may be connected to the data platform 200, the application platform 100, the third-party application 500, and/or the one or more user terminals 400 via at least one network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, etc.), a public land mobile network (PLMN), a telephone network (e.g., the Public Switched Telephone Network (PSTN)), or the like, and/or a combination of these or other types of networks. The communication interface 310 may include at least one of an Ethernet interface, an optical interface, a coaxial interface, an infrared interface, a radio frequency (RF) interface, a USB interface, a Wi-Fi interface, a cellular network interface, or the like.

The dataset engine 320 is configured to receive (e.g., request or retrieve) one or more datasets from the data platform 200, via the communication interface 310, and process the data in accordance with a user request. For example, the dataset engine 320 may process the user request and perform an associated action based thereon, such as access a requested dataset from the data platform 200, standardize a form or format of the dataset, and provide the dataset to the visualization engine 330. For example, the data (or datasets) obtained from different applications may be of different formats. Accordingly, the dataset engine 320 converts a format(s) of the datasets into a standardized format for the data management system.

According to an embodiment, the dataset engine 320 may process raw or native data provided by the applications in the application platform 100 to generate datasets or data cubes having a standardized format, and store the datasets or data cubes in the data platform 200. According to another embodiment, a distinct dataset engine (e.g., included in the application platform 100 or the data platform 200) may process native data output by the applications into a standardized format for retrieval and processing by the dataset engine 320 in accordance with a user request.

The visualization engine 330 is configured to create, modify, refresh, and/or publish a data visualization (e.g., report, and/or dashboard) in accordance with a user request. For example, the visualization engine 330 may generate or modify the fields or components of a data visualization (e.g., dashboard, report template, etc.) in accordance with a user request. Further, the visualization engine 330 may obtain, from the dataset engine 320, datasets required to populate the data visualization in response to a user request or based on a predefined (e.g., default or user set) refresh period for a previously generated data visualization.

The data visualization storage 340 is configured to store data visualizations and/or templates generated or provided by the visualization engine 330. The data visualization storage 340 may include any device capable of storing data, such as a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. The data visualization storage 340 may be implemented as a plurality of storage devices. Further, the data visualization storage 340 may store metadata, attributes, or information regarding each data visualization. For example, the metadata, attributes or information may include at least one of a creator (user information) of the data visualization, one or more applications (or modules) that are source of a dataset presented or used by the data visualization, a date and/or time of creation of the data visualization, and a name of the data visualization. The metadata, attributes, or information may be stored together with the data visualization (e.g., within the same file) or separately from the data visualization.

The API storage 350 is configured to store a plurality of APIs for accessing features of the centralized data management system 300. In one or more embodiments, the APIs contain or manage a list of features provided by the centralized data management system 300 (e.g., viewing report A, configuring dashboard B, etc.), and information of users associated with the features (e.g., ID of users who have access to such features, etc.). The APIs may be created by the centralized data management system 300 or provided by one or more external sources. The API storage 350 may include any device capable of storing data, such as a hard disk (e.g., a magnetic disk, an optical disk, a magneto-optic disk, and/or a solid state disk), a CD, a DVD, a floppy disk, a cartridge, a magnetic tape, and/or another type of non-transitory computer-readable medium, along with a corresponding drive. The API storage 350 may be implemented as a plurality of storage devices. The data visualization storage 340 and the API storage 350 may be physically distinct storages or may be logically distinct storages within a same storage device. According to an embodiment, the API storage 350 may be or include an API gateway.

The security platform 360 is configured to authenticate users accessing the data management system 300, and to manage access rights of users and/or applications to the data management system 300. The security platform 360 may store and/or manage at least one of user authentication information, application access rights, user access rights, group access rights, and data management access rights.

The database 365 is configured to store a plurality of data, such as raw data obtained by sources, query data, etc., and the data may be retrieved by the data management system 300 (e.g., in response to a user input) to be presented to the user as is described in detail below. In some embodiments, the data visualization storage 340, API storage 350, and database 365 are included as one data storage. In some embodiments, the database 365 may be omitted and the data platform 200 may perform the functions of the database 365.

The controller 370 is configured to control overall operations of the centralized data management system 300 and the components thereof. The controller 370 may include at last one processor (e.g., a central processing unit (CPU), a system-on-chip (SoC), an accelerated processing unit (APU), a microprocessor, a microcontroller, a digital signal processor (DSP), a field-programmable gate array (FPGA), an application-specific integrated circuit (ASIC), a backend processing engine, or another type of processing component). In some implementations, the controller 370 includes one or more processors capable of being programmed to perform a function. The controller 370 may also include at least one memory, such as a random-access memory (RAM), a read only memory (ROM), and/or another type of dynamic or static storage device (e.g., a flash memory, a magnetic memory, and/or an optical memory) that stores information and/or instructions for use by the at least one processor.

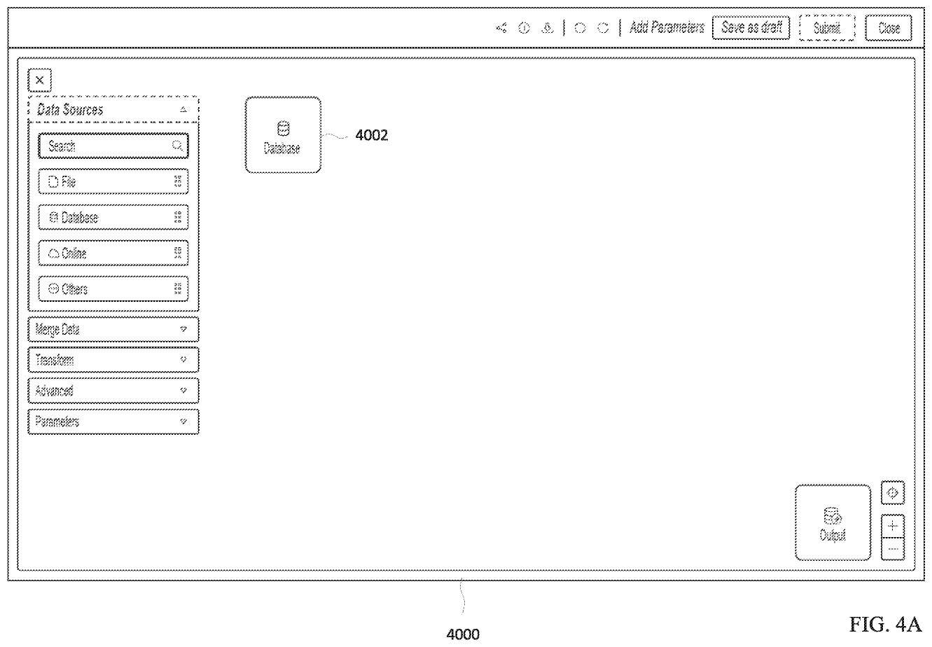

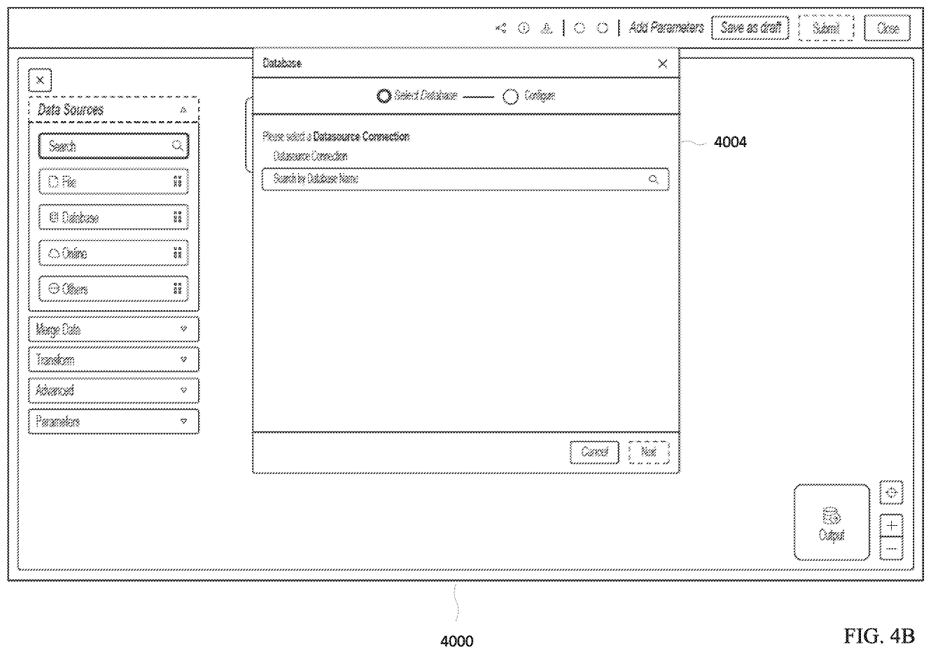

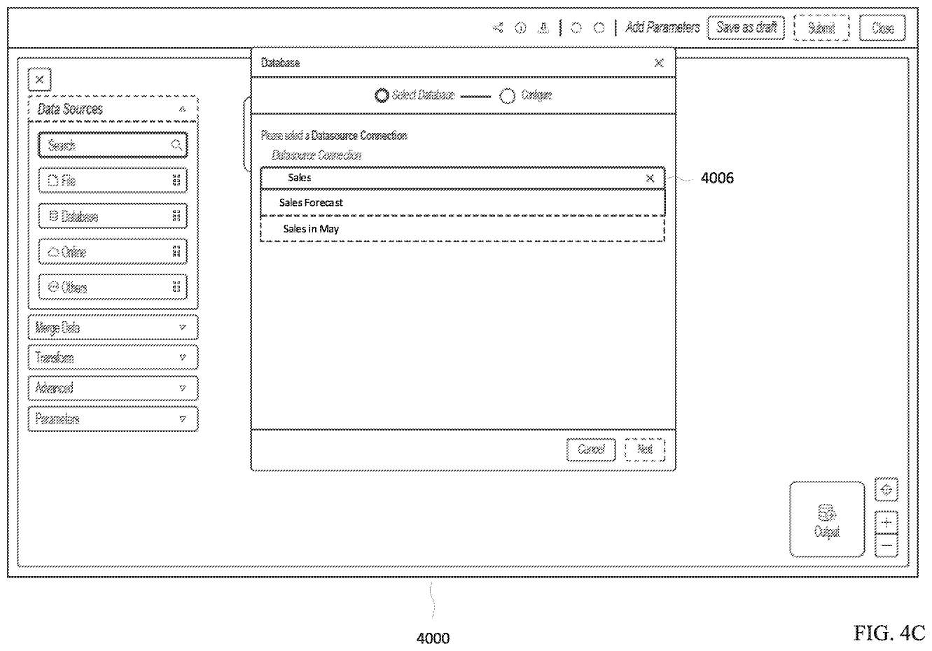

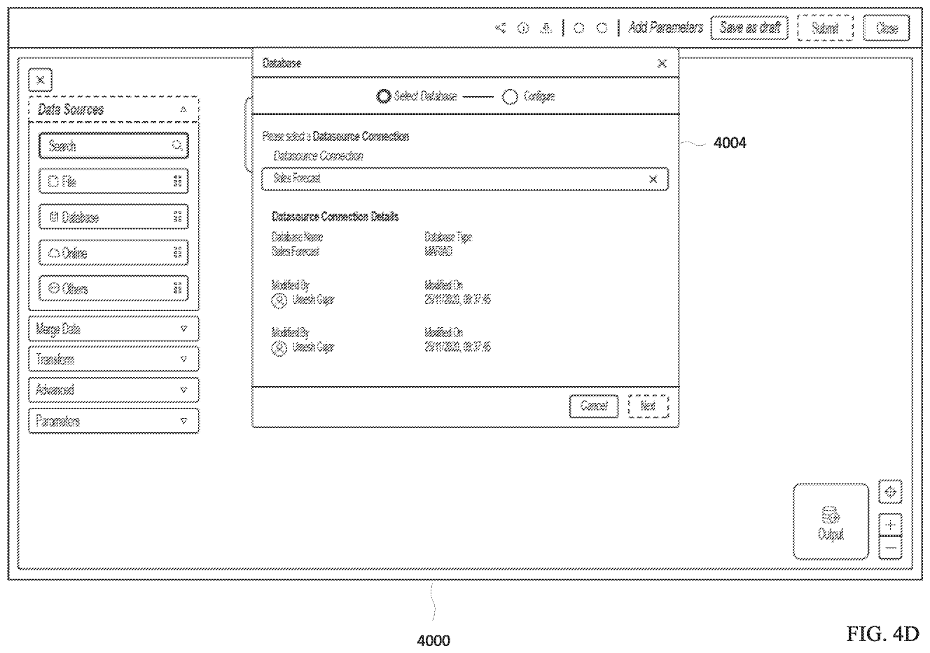

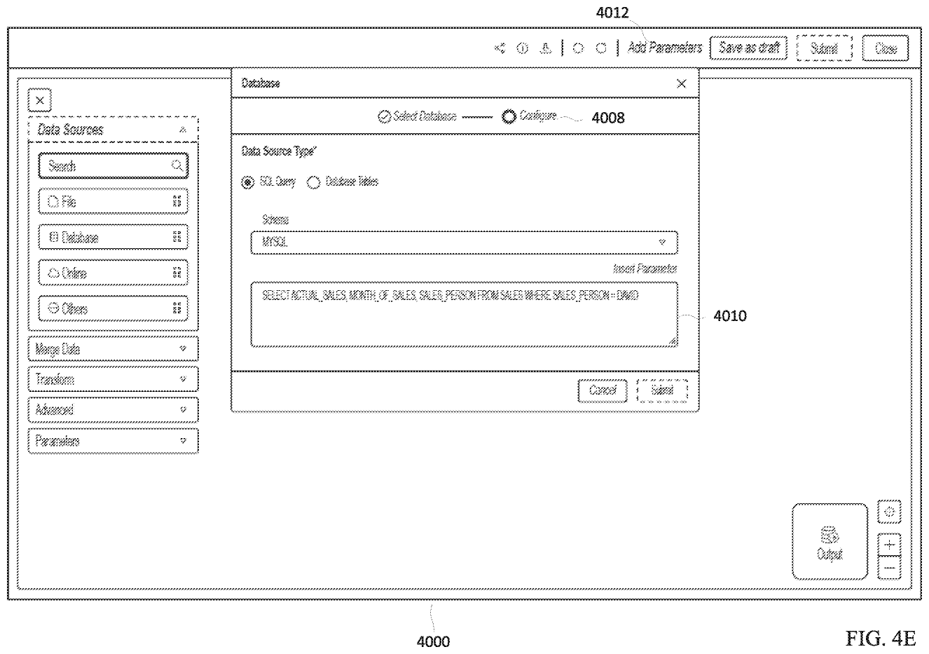

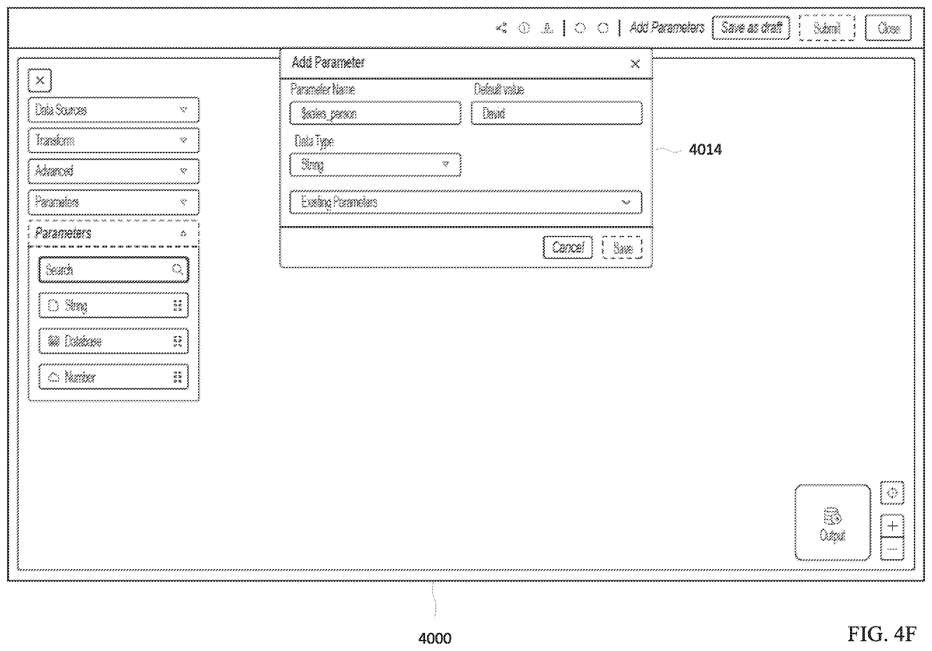

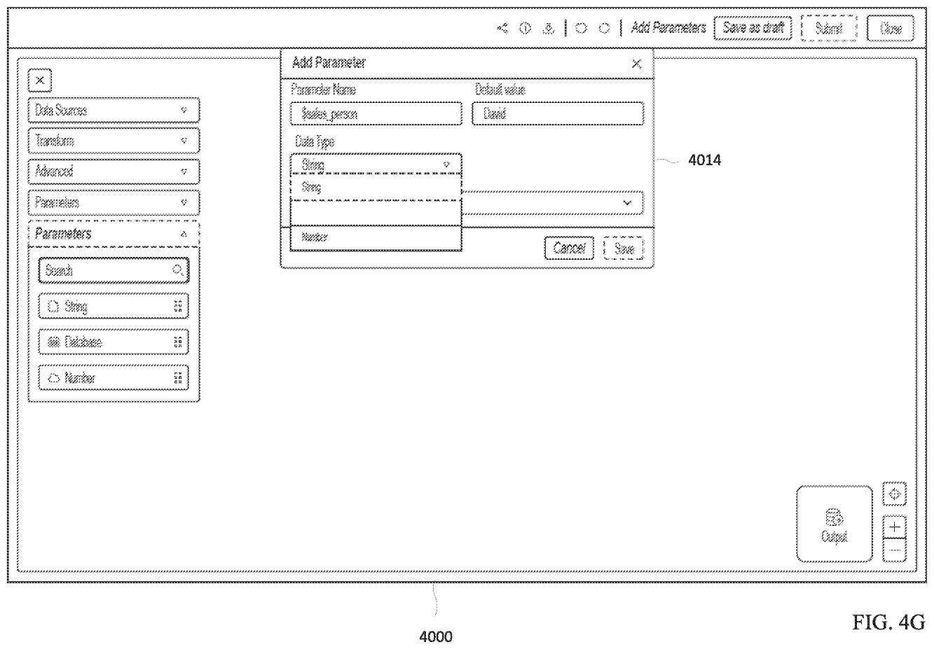

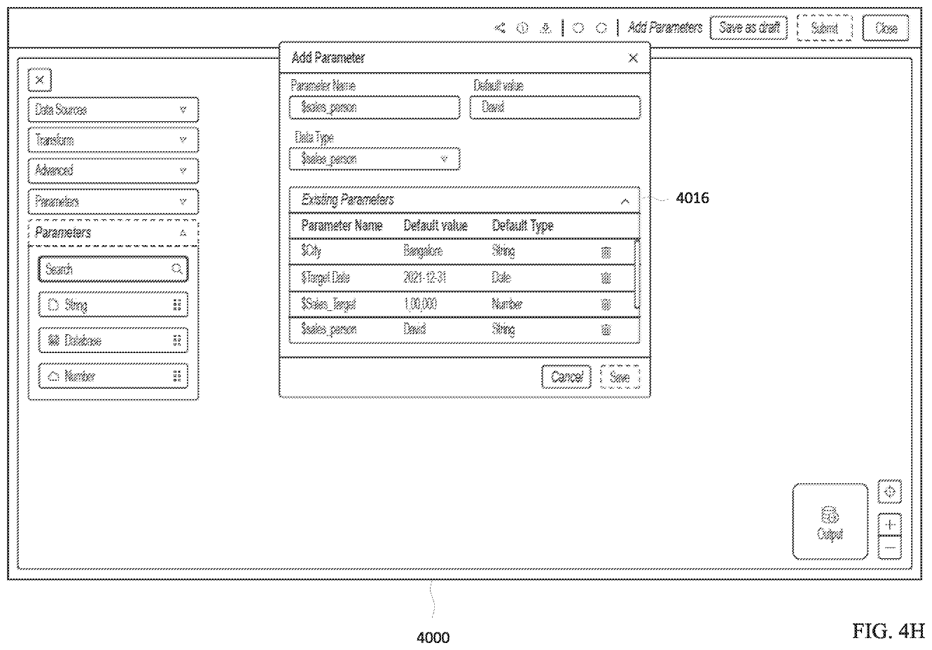

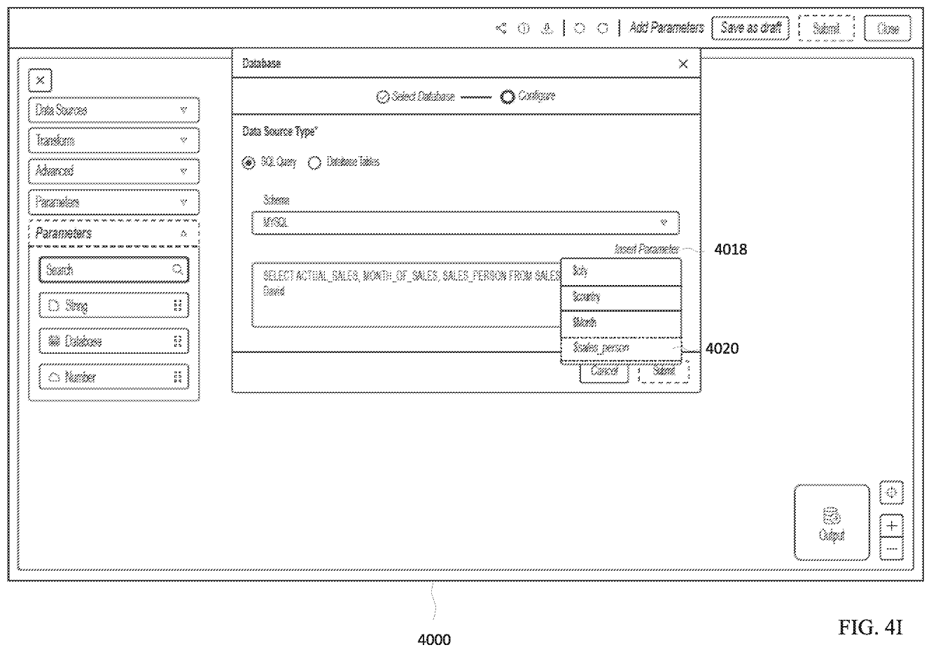

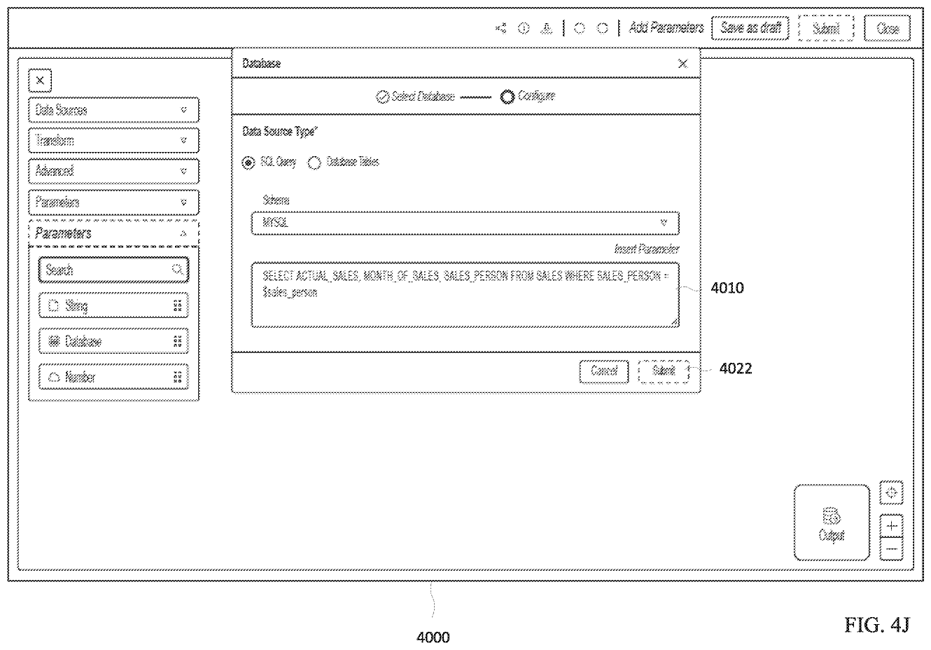

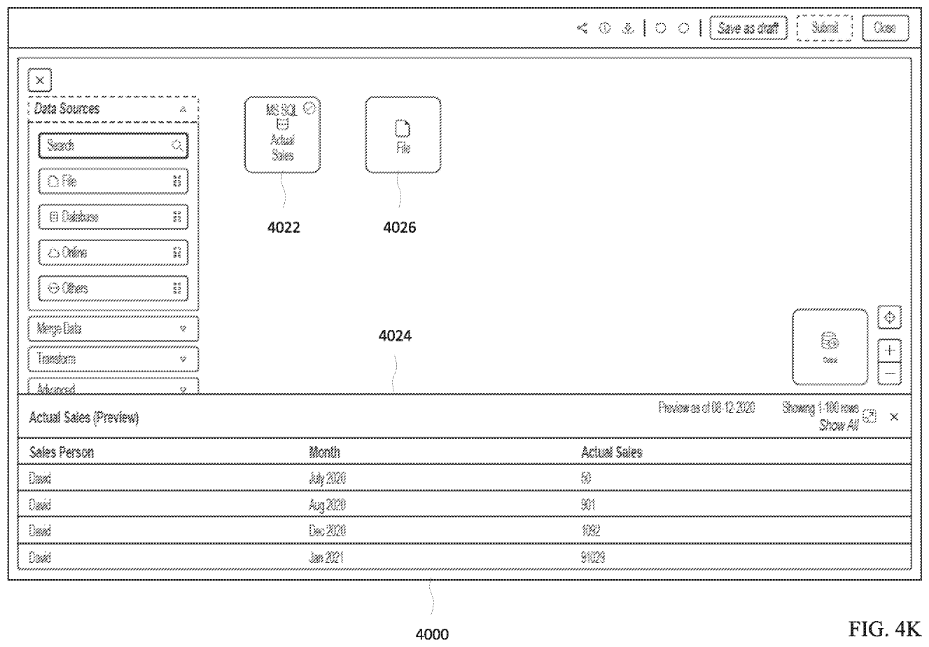

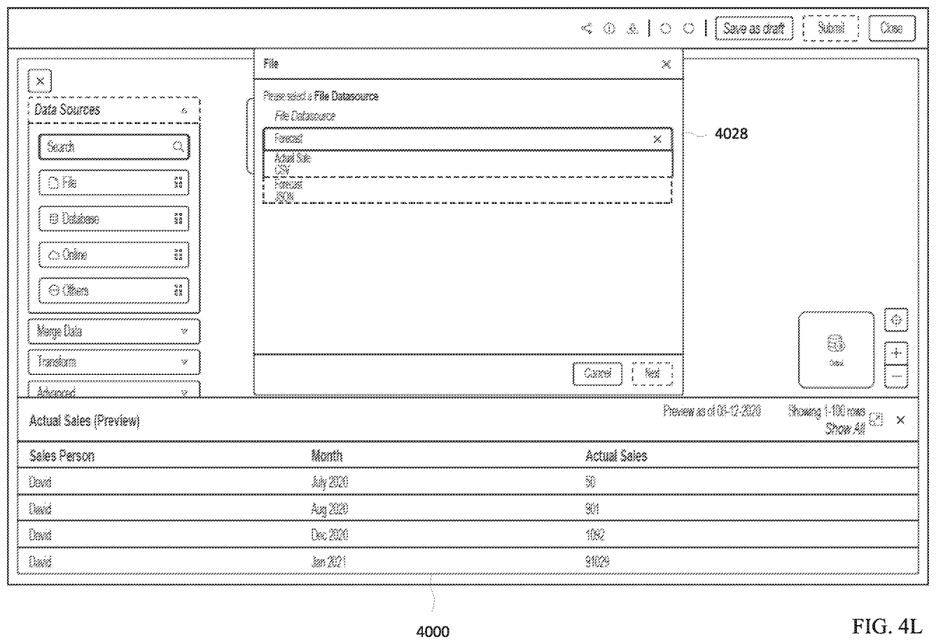

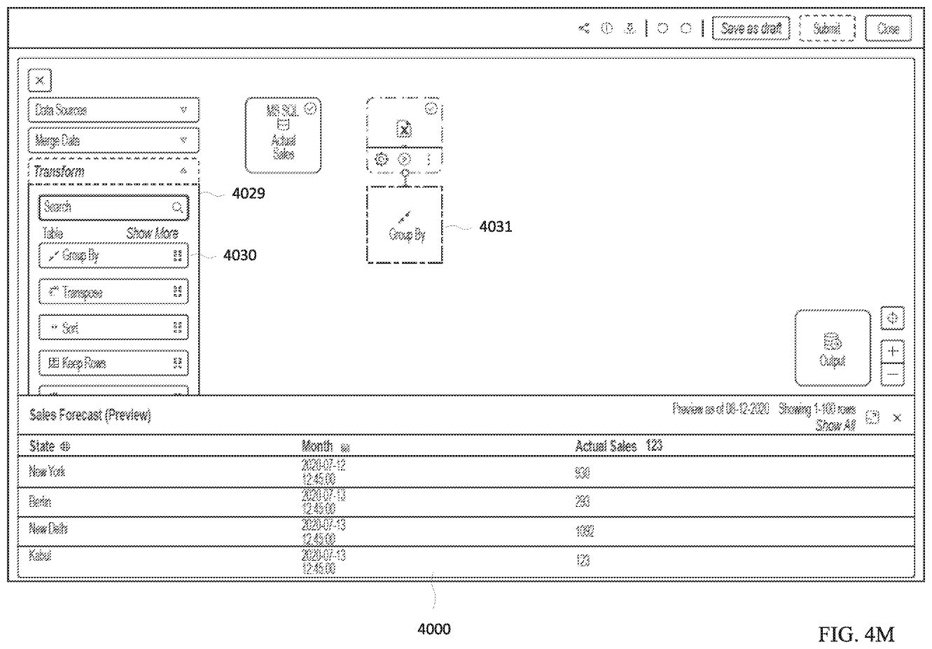

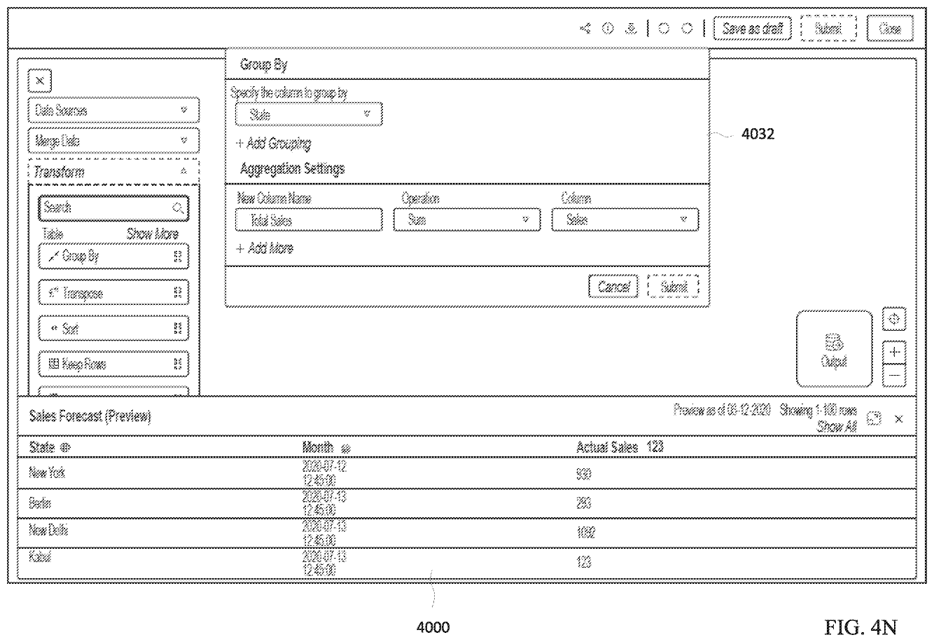

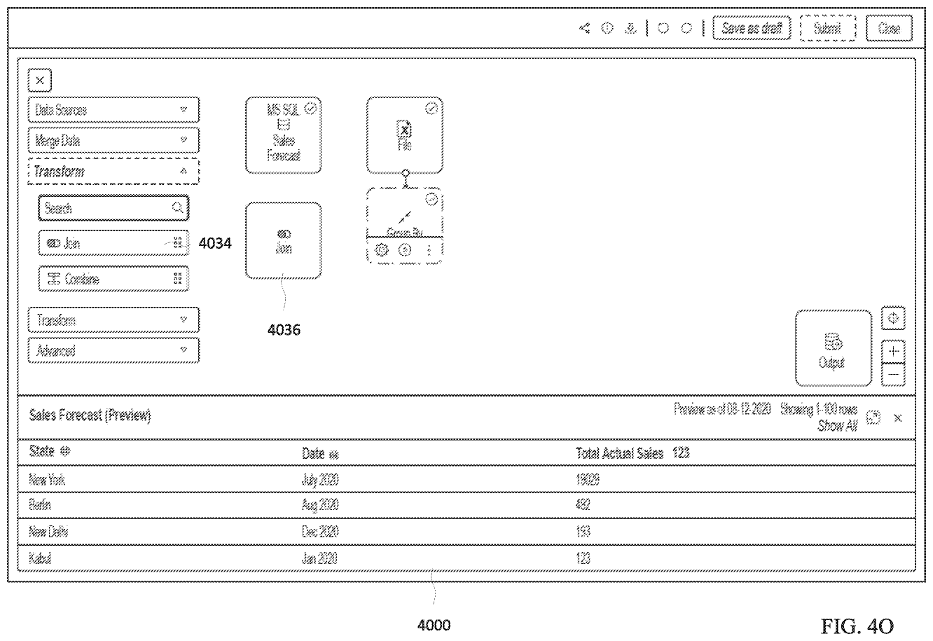

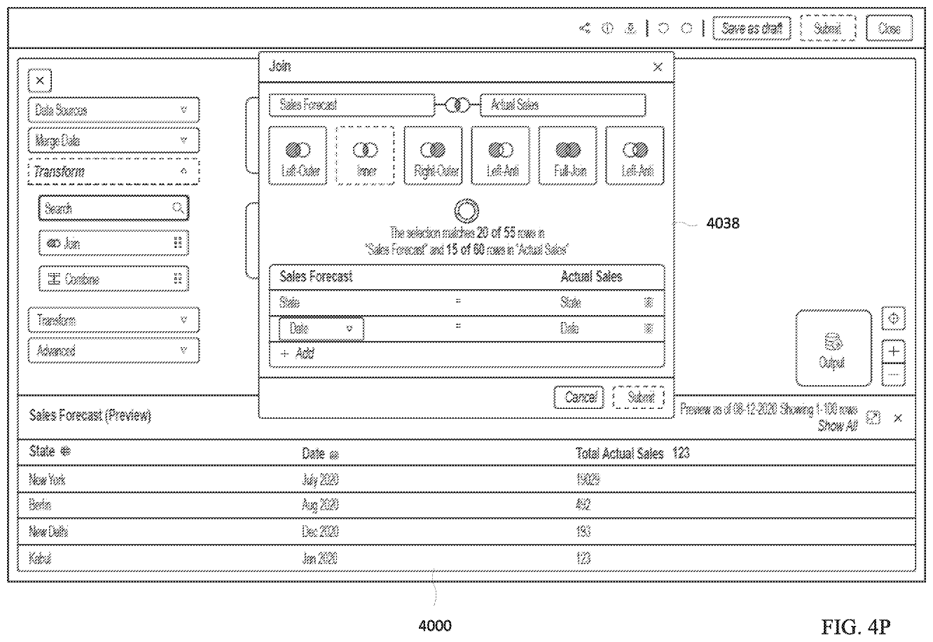

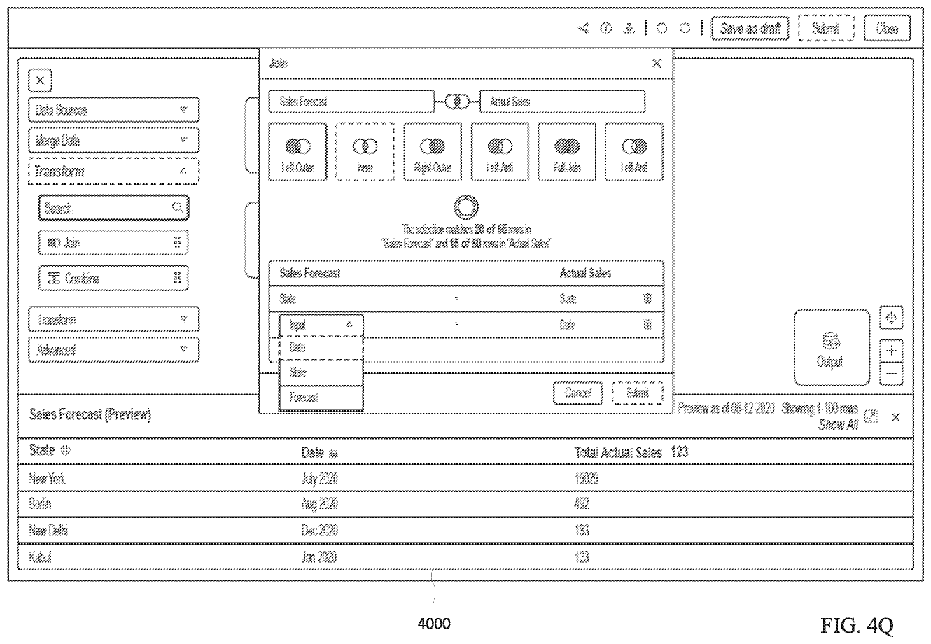

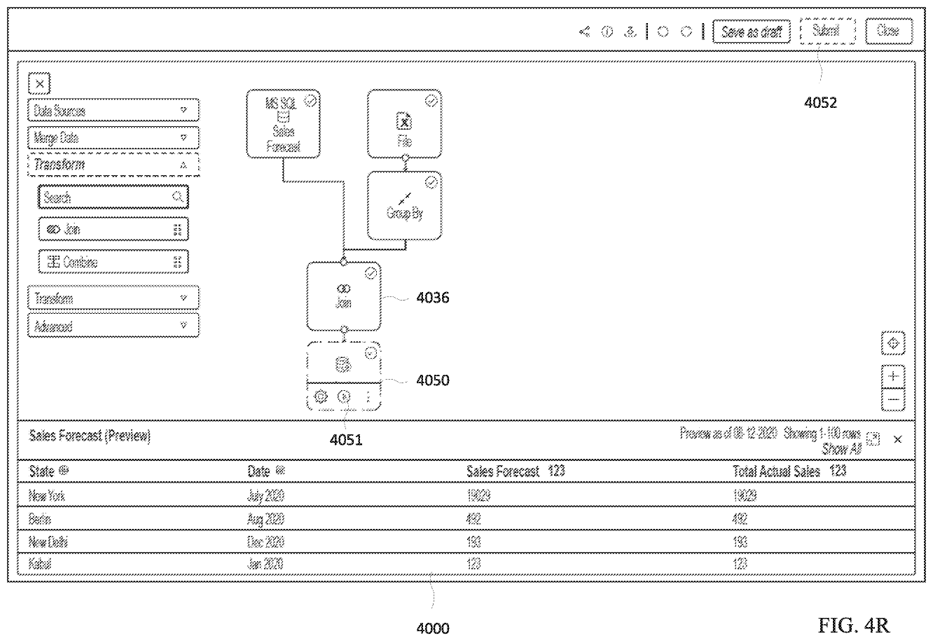

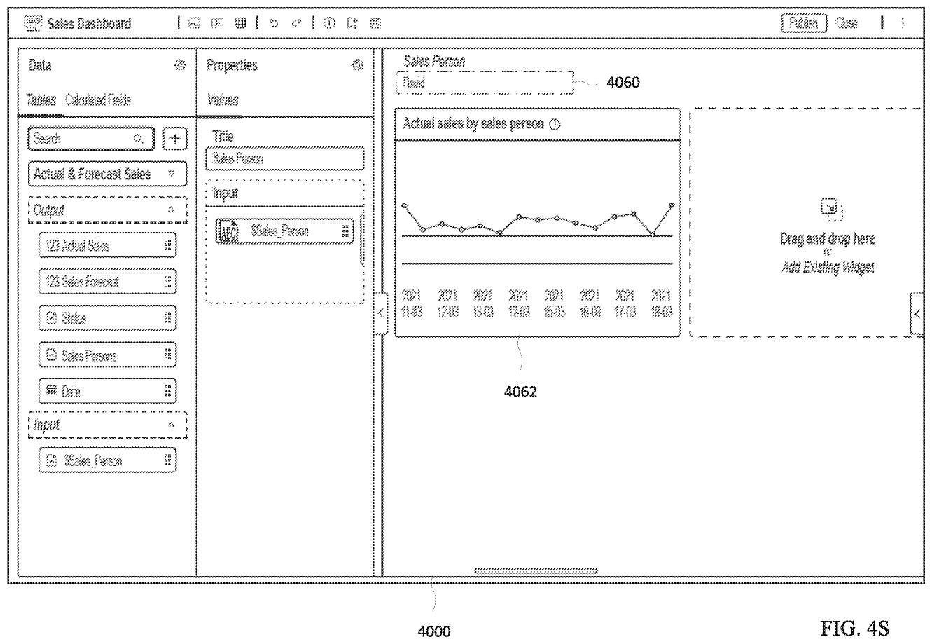

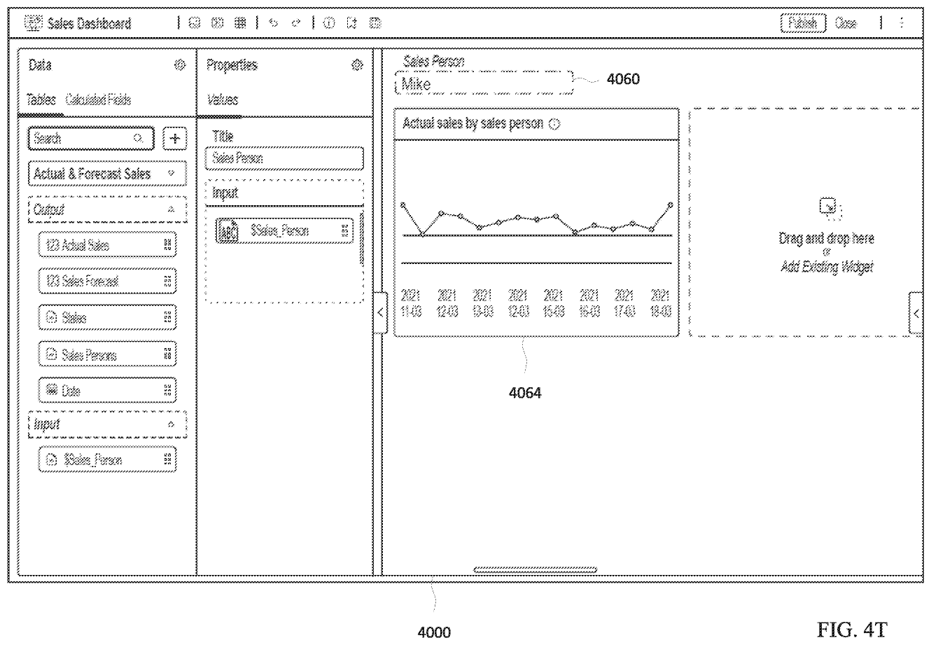

The controller 370 may be configured to generate a graphical UI and to provide the graphical UI to a user terminal 400 via the communication interface 310, in order to allow for access to the centralized data management system 300. The graphical UI (e.g., a webpage or markup language file) may be stored in a storage (which may be included in or external from the centralized data management system 300). According to another embodiment, the graphical UI may be stored in an external server. The graphical UI may be accessed by the user terminal 400 via a location identifier or address (e.g., uniform resource indicator (URI), a uniform resource locator (URL), a file path, etc.). The graphical UI allows an end user to perform an action with the centralized data management system 300 (such as generate a data visualization, view a certain data visualization, configure the data illustration or reporting format in a data visualization, etc.) via certain functional elements presented on the graphical UI, such as buttons, scroll bars, etc. Further, the graphical UI may allow a user (or a particular type of user, such as an Administrator or the creator of a data visualization) to set or edit the access rights for a data visualization (e.g., user access rights, application access rights, group access rights, data visualization access rights, etc.). A graphical UI for generating a data visualization according to an embodiment is described in further detail below with reference to FIGS. 4A-4T.

According to one or more embodiments, the controller 370 (e.g., at least one processor executing instructions) controls operations of at least one of the communication interface 310, the dataset engine 320, the visualization engine 330, the data visualization storage 340, the API storage 350, the database 365 and the data processing engine 366 to generate a data visualization in accordance with a user request.

For example, the controller 370 may receive, from a user terminal 400 via the communication interface 310, a user request to generate a data visualization. The request may be received via the graphical UI displayed or output by the user terminal 400. As described above, the graphical UI may be provided by the centralized data management system 300 via the communication interface 310 or may be stored in an external device or server. Alternatively, the graphical UI may be provided by another application in some embodiments (e.g., a third-party application 500 or an application in the application platform 100).

In accordance with an embodiment, the graphical UI allows an end user to define and/or configure a desired data visualization (e.g., generated report, report template, data visualization, and/or dashboard) for presenting data (e.g., data associated with an application of application platform 100, data associated with a third-party application 500, data associated with the centralized data management system 300, data associated with the user, etc.) stored in the data platform 200. For example, through the graphical UI, the end user is able to configure the data visualization by selecting data fields as well as types and/or roles for each field to be used (e.g., types of measures or data calculated or aggregated from data available in the data platform 200, dimensions or qualitative data, etc.), an arrangement of the fields, graphical representations of the fields (e.g., graphs, charts, etc.), display positions of one or more components of the data visualization, etc. The fields and/or their definitions may be selected from among a plurality of predetermined or previously-generated fields, measures, dimensions, etc., or may be newly-defined by the end user. The graphical UI allows the end user to select data fields based on data from a plurality of different applications (and of a plurality of different native formats), for inclusion, processing, and/or presentation/visualization in the same data visualization. Further, through the graphical UI, the end user may define an aggregation for every measure, may select a report output type (e.g., CSV, PDF, etc.), may define filter parameters based on available data, may set an auto refresh period for refreshing the data visualization, and/or may manage user access by specifying authenticated users or authenticated user roles or permissions, application rights, group rights, etc. In some embodiments, through the graphical UI, the end user may select a previously generated data visualization stored in the data visualization storage 340, and modify the previously generated visualization to create a new data visualization. Further, in one or more embodiments, a user may select for inclusion in a data visualization one or more graphical representations (e.g., widgets or tiles in which a graph, chart, etc., is presented) from among previously generated graphical representations (e.g., previously generated for another data visualization), or from among stored predefined templates for graphical representations.

The controller 370 is configured to receive the user selections made via the graphical UI, and control the visualization engine 330 to generate the data visualization accordingly. Further, the controller 370 may be configured to store the generated data visualization in the data visualization storage 340.

The controller 370 is configured to populate or publish the data visualization with data stored in the data platform 200. For example, in response to a user's request (e.g., via the graphical UI) to add data to or generate a data visualization, view a data visualization, and/or refresh a data visualization, the controller 370 controls the dataset engine 320 to determine the data needed for the data visualization, access one or more corresponding datasets from the data platform 200, standardize the datasets, and provide the datasets to the visualization engine 330. According to another embodiment, the datasets may be standardized beforehand, e.g., upon or based on storage in the data platform 200. Further, the controller 370 is configured to control the visualization engine 330 to process the datasets (e.g., aggregate the data, perform calculations, generate visualization items or graphical representations (e.g., graphs, charts, etc.), consolidate the data, etc.) to obtain data for the data visualization, and update or populate the data visualization with the obtained data. Additionally, the controller 370 is configured to control the visualization engine 330 to modify presentation parameters or styles (e.g., colors of bars or parts of a graph, pie chart, etc., an orientation of a chart or graph, X- and Y-axes of a graph, etc.).

The controller 370 may control to store the populated data visualization in the data visualization storage 340. For example, the controller 370 may control to store the populated data visualization and metadata indicative of a date and/or time that the data visualization is generated or populated with the data. The data visualization storage 340 may store a data visualization template in addition to a plurality of different versions of the same data visualization, corresponding to different dates and times in which the data visualization template is populated or updated with data. Further, the data visualization storage 340 (or an additional storage) may store sub-parts of the data visualization (e.g., graphical representations (such as tiles or widgets in which charts, graphs, etc., are included)) that can be individually selected at a later time by a user for inclusion in another data visualization.

The controller 370 is configured to transmit or provide the generated data visualization to the user terminal 400 via the communication interface 310.

When a user accesses the system 300 to view data from the database 365 that includes multiple data, the user may use a user terminal 400 to access the centralized data management system 300. The visualization engine 330 may generate and provide a UI for the user to access. A processor of the centralized data management system 300 may determine a role of the user based on a user credential, and provide the UI to the user based on the determined role. In some embodiments, a single UI is generated for users regardless of a user role.

The UI may include various interactive elements, such as buttons, charts, widgets, blocks, etc. Each of the interactive elements may represent a group of predefined queries (e.g., SQL queries) that may be defined by, for example, a system administrator, the user, etc. The interactive elements may include elements representing data stored in the database 365 and element representing a function, such as join, group, etc. Via the UI, the user may select an interactive element associated with the desired data, and then select an interactive element associated with the desired function to be performed on the desired data. Combinations of data interactive elements and function interactive element may be implemented. Based on the selection of interactive elements, the user may indicate to the centralized data management system 300 that the selection of interactive elements has been completed (e.g., pressing a “process” button).

The data processing engine 366 may be configured to determine a query template of the selected functions (e.g., selected function interactive element(s)) and a query subject label of each of the selected data (e.g., selected data interactive element(s)). Additionally or alternatively, in some embodiments, the dataset engine 320 and/or the data platform 200 may perform the functions of the data processing engine 366. The data processing engine 366 may be configured to insert the query subject label into the query template to generate an executable query. The data processing engine 366 may be configured to execute the executable query to generate the data as requested by the user. The generated data may be provided by the data processing engine 366 to the visualization engine 330. The visualization engine may be configured to generate and present a visualization of the generated data to the user.

In one embodiment, when a user desires to view and generate a dataset of a combination of “Sales Forecast” and “Actual Sales,” the user may select a block element representing “Sales Forecast” data and a block element representing “Actual Sales” data, and then select a function block element representing a “Join” function.

Each of the block elements representing the data may include a query subject label and each of the function block elements may include a predefined query template. In the above example, the block element of “Sales Forecast” includes a query subject label of “sales_forecast”, the block element of “Actual Sales” includes a query subject label of “actual_sales,” and the block element of the “Join” function includes a predefined template of a query for joining multiple subjects. The subjects in the query template may be dynamic (i.e., changeable). The data processing engine 366 may be configured to collect the query subject labels (i.e., in this example, the selected subject will be “sales_forecast” and “actual_sales”) for the data selected by the user, and insert the query subject labels as the subjects in the query template, so as to generate an executable query.

The data processing engine 366 may run the generated query, extract the associated data from the data storage, process the extracted data based on the generated query, and then provide the generated data to the visualization engine 330. The visualization engine 330 may be configured to further process the generated data to generate a visualization (e.g., a table, a chart, etc.) of the data. The visualization engine 330 may be configured to then present the visualization of the data to the user via the UI.

In some embodiments, the user may configure or change the visualization of the data via the UI. For example, the user may be configure or change a dynamic element of the query via the UI. The visualization engine 330 may be configured to determine the changes made by the user and send the changes to the data processing engine 366. The data processing engine 366 may be configured to generate a new query based on the changes made by the user. The data processing engine 366 may be configured to generate a new set of data based on the new query, provide the new set of data to the visualization engine 330, and the visualization engine 330 may be configured to update the visualization of the data via the UI. Accordingly, the centralized data manage system 300 allows the user to change or configure the data visualization dynamically and during operation of the centralized data management system 300, without requiring the user to reconfigure (i.e., reinitialize) the query. Although the interactive elements may include a respective predefined query (e.g., predefined by a data scientist, a system administrator, or personnel with knowledge in the query and dataset), the user may modify/configure the query (e.g., via a query editing window presented on the UI, etc.).

A dashboard created from the centralized data management system 300 may include charts/widgets. For creating the chart/widget, a data (e.g., data table) is provided as and input. The data is obtained from a data storage (e.g., the database 365) through a query. The centralized data management system 300 provides an ability to build or modify this query dynamically while the user interacts with the interactive elements (e.g., charts/widgets) in the dashboard generated by the visualization engine 330.

When the user creates the query, the user may introduce parameters (e.g., dynamic parameters) to replace parts of the query to be substituted through an input on an interactive element on the UI (e.g., charts/widgets). Once the user introduces a parameter for the query, the user may specify a default value for the query parameter and a data type of the query parameter. The query may include an input (e.g., query parameters) based on which the query can be built/changed dynamically through an input to the UI, and an output providing the data for the interactive element(s).

The output of the query providing the data may be mapped to an interactive element in the dashboard. The input of the query may be mapped to input controls (e.g., an input box, a drop down box, a date picker, etc.) in the dashboard based on, for example, the data type of the parameter. When the input of the query is mapped to an input control, and the value of the input control is changed in the UI by a user, the value of the query parameter changes. A new query is built each time the input value of the input control changes, thereby providing a dynamic query.

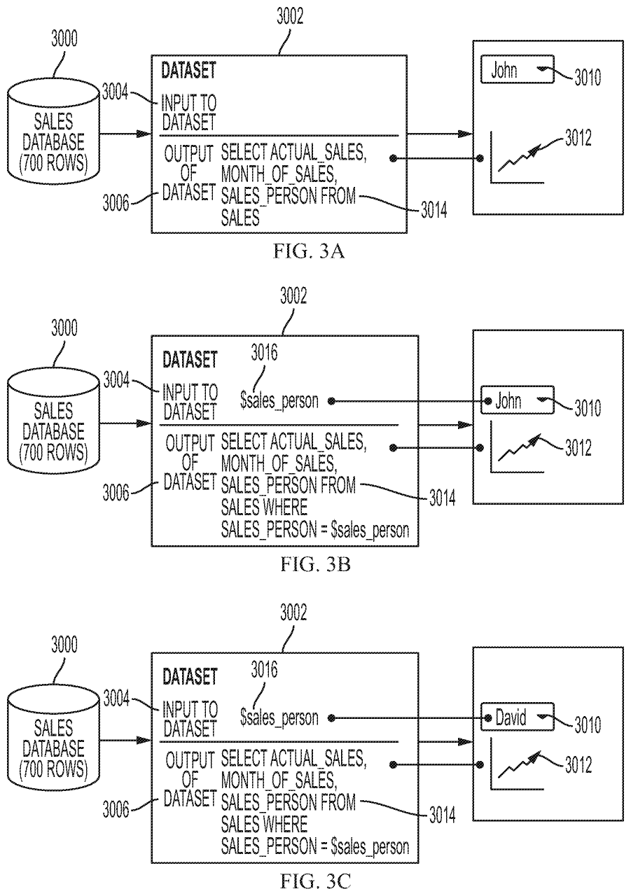

FIGS. 3A, 3B and 3C are diagrams illustration a system operation with a dynamic parameter, according to an embodiment. The system includes a sales database 3000, a dataset 3002 including an input 3004 and an output 3006, and a UI 3008 that includes an input control 3010 and a visualization 3012 corresponding to the dataset output 3006. In some embodiments, the sales database 3000 is included in the data platform 200. In FIG. 3A, the database output 3006 corresponds to the query 3014 (e.g., SELECT ACTUAL_SALES, MONTH_OF_SALES, SALES_PERSON FROM SALES). The query 3014 directs the system to obtain the data corresponding to “ACTUAL_SALES”, “MONTH_OF_SALES”, and “SALES_PERSON” data from the sales database 3000, such that the “ACTUAL_SALES” and “MONTH_OF_SALES” are obtained for each “SALES_PERSON” from the sales database 3000.

In FIG. 3B, the system introduces a dynamic parameter 3016 for the query 3014. The query 3014 is changed to “SELECT ACTUAL_SALES, MONTH_OF_SALES, SALES_PERSON FROM SALES WHERE SALES_PERSON=$sales_person”. The input control 3010 may include a drop down box that allows a user to select or input a name of a sales person, and the selection is provided to the dataset 3002 as a dynamic parameter $sales_person 3016. Thus, the sales person “John” is input to the dataset 3002, and the output of the dataset 3002 is the dataset corresponding to sales person “John”.

In FIG. 3C, the system receives an input from the user via the input control 3010 to change the sales person from “John” to “David”. The sales person “David” is input to the dataset 3002, and the output of the dataset 3002 is the dataset corresponding to sales person “David.” By using the query 3014 with the dynamic parameter 3016, the system provides dynamic visualizations while referring to the dataset 3002 rather than all the way back to the sales database 3000. That is, the filtering based on the sales person is performed at the dashboard level (e.g., the UI) rather than the query level (i.e., without re-writing a new query language and re-accessing the sales database 3000).

Referring back to FIG. 2, when a user selects to view sales data, the data processing engine 366 is configured to retrieve all data associated with the sales, process the data to determine the selectable options (e.g., sales category, sales person, etc.), and provide the results to the visualization engine 330. The visualization engine 330 is configured to produce and present an interactive element (e.g., a drop-down list, the input control 3010, etc.) to the user to allow the user to further select or input the specific data that the user wants to view. Subsequently, the visualization engine 330 is configured to provide the selection of the user to the data processing engine 366, and the data processing engine 366 will further process (e.g., filter, etc.) the data and provide the processed data to the visualization engine 330. The visualization engine 330 is configured to then generate/update the data visualization (e.g., the visualization 3312) such that the data visualization contains the requested data.

FIGS. 4A-4T are diagrams of a UI for generating queries and data visualizations, according to an embodiment. Referring to FIG. 4A, the UI 4000 may include an interactive element 4002 for selecting a database. When interactive element 4002 is selected, as shown in FIG. 4B, the user interface 4000 displays a window 4004 for selecting a database. As shown in FIG. 4C, in some embodiments, a user may input a keyword to a search bar 4006, and the system (e.g., the data processing engine 366) will search available databases associated to the keyword and present the results in a drop down box. The user may interact with the drop down box to select a desired database(s) from which data is to be queried. As shown in FIG. 4D, when the “Sales Forecast” database is selected, the window 4004 may display information regarding the database.

As shown in FIG. 4E, the user may select the configure button 4008 to manually configure a query associated to the selected database (e.g., an SQL query). The UI 4000 may also display the current query (e.g., a pre-set query, a query template, etc.) in the query dialog box 4010. The user may select the “Add Parameter” button 4012 to insert a static or dynamic parameter into the query. When button 4012 is selected, as shown in FIG. 4F, the UI 4000 displays an add parameter window 4014 that allows a user to input or select a desired parameter based on the parameter name, a default value of the parameter and the data type of the parameter. As shown in FIG. 4G, the data type of the parameter may vary, including a string data type, a number data type, or any other suitable data type. As shown in FIG. 4H, the system may store existing parameters, which may be displayed to a user when the existing parameters drop list 4016 is selected.

As shown in FIG. 4I, when the parameters have been added, the user may select the “Insert Parameter” button 4018 to insert a dynamic parameter into the query. Although the dynamic parameters shown include city, country, month, and sales_person, the type of dynamic parameter is not limited to such data as the type of dynamic parameter may depend on the overall context of the data in the database. In some embodiments, the system automatically generates and presents suggestion of dynamic parameter based on the selected database (e.g., if the system determines that a sales related database is selected, the system will generate a suggestion on dynamic parameters, such as “sales_person”, for the user's selection). When the user selects “$sales_person” 4020 as the dynamic parameter to insert, as shown in FIG. 4J, the parameter 4020 is inserted in the query, as shown in the query dialog box 4010. The user may then select the “submit” button 4022 to complete the query, and, as shown in FIG. 4K, the UI 4000 may present an interactive element 4026 corresponding to the query (e.g., corresponding to the data retrieved based on the query). The UI 4000 may also present a preview 4024 of the retrieved data. In some embodiments, when a user moves a mouse cursor to a block or interactive element, an interactive object (e.g., a play button, such as button 4051 in FIG. 4R) may be presented, and, when the cursor interacts with the interactive object, the system may generate a presentation of the preview 4024 Thus, as shown in FIGS. 4A-4K, the UI 4000 provides access to a user to either set a dynamic parameter by directly editing the query text or by selecting dynamic parameter from the provided windows, such that the user does not require knowledge of the query language to generate a query.

The user may select interactive element 4026 to select a file datasource, and, as shown in FIG. 4L, the UI 4000 may display a file datasource selection window 4028. Once a file datasource is selected, as shown in FIG. 4M, the user may select the transform dropbox 4029 and a “Group By” option 4030 for grouping data. The UI 4000 may display an interactive element 4031 corresponding to a grouping function that is arrangeable on the UI 4000. When the element 4031 is selected, as shown in FIG. 4N, the UI 4000 may display a group by window 4032, where the user may configure or specify how the grouping function will group the data.

The user may then select a “Join” option 4034 from the transform dropbox 4029, and, as shown in FIG. 4O, the UI 4000 may display an interactive element 4036 corresponding to the joining function that is arrangeable on the UI 4000. As shown in FIG. 4P, when the element 4036 is selected, the UI 4000 may display a joining window 4038, where the user can select various options for joining data, as shown in FIG. 4Q. Once the parameters of the joining function are selected, as shown in FIG. 4R, the output interactive element 4050 may be arranged to be moved to the join interactive element 4036.

Combining and linking the functional blocks generates a new query. Each of the transform functions (e.g., join, group, etc.) includes a pre-built query for performing the intended functions. That is, each may function as a block of a pre-built query, such that, when the user selects the function block and links it to the dataset, the system determines a combined query). The system may apply the combined query to the dataset so as to process the data based on the intended features (e.g., filter, join, group, etc.). Thus, the user does not need to know the exact query language of each of the transformation functions. Instead, the user may easily select the function blocks and link them via the UI.

When the overall flowchart is formed through arrangement of the interactive elements, the user may select the “Submit” button 4052 to generate visualizations and modifiable options. In some embodiments, the user can press a button (e.g., a play button as presented in FIG. 4R) on the interactive element 4050, and the system will continuously retrieve the latest associated data from the selected database and automatically update the preview window to present a preview of the latest processed dataset in real time.

As shown in FIG. 4S, the UI 4000 may display the dynamic parameters (e.g., sales person in the above described embodiments) 4060 and a first visualization 4062 according to the selected dynamic parameters. As shown in FIG. 4T, the user may change the dynamic parameter from “David” to “Mike,” and the UI 4000 may display a second visualization 4064 based on the changed dynamic parameter 4060. Therefore, the user can generate multiple visualizations based on the retrieved data using various values of the dynamic parameters without the need to generate a new query each time and without the need to retrieve further data from the database. Although only one dynamic parameter is shown in the illustrated embodiment, the system provides capabilities for multiple dynamic parameters to be implemented and changed accordingly.

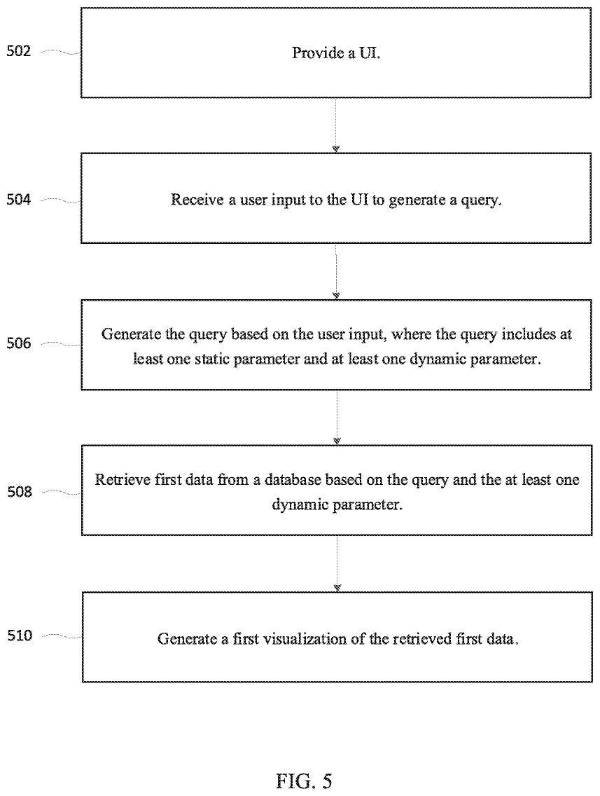

FIG. 5 is a flowchart of a method of retrieving data, according to an embodiment. In operation 502, the system provides a UI to a user. In operation 504, the system receives a user input to the UI to generate a query. In operation 506, the system generates the query based on the user input, where the query includes at least one static parameter and at least one dynamic parameter. In operation 508 the system retrieves first data from a database based on the query and the at least one dynamic parameter. In operation 510, the system generates a first visualization of the retrieved first data.

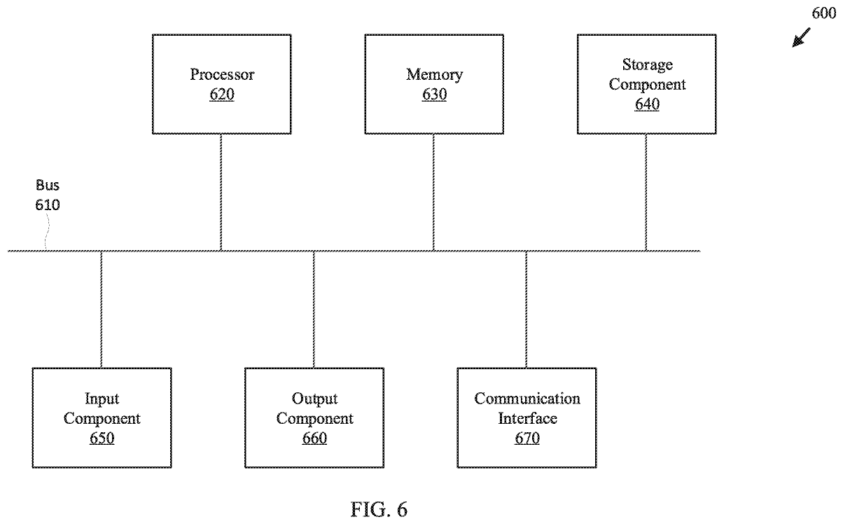

FIG. 6 is a diagram of components of one or more devices according to an embodiment. Device 600 may correspond to a computing device described above (e.g., at least one server or device that implements or embodies the data visualization system 300, at least one server or device that stores or deploys the application platform 100, at least one server or device that implements or embodies the data platform 200, at least one user terminal 400, etc.).

As shown in FIG. 6, the device 1000 may include a bus 610, a processor 620, a memory 630, a storage component 640, an input component 650, an output component 660, and a communication interface 670. It is understood that one or more of the components may be omitted and/or one or more additional components may be included.

The bus 610 includes a component that permits communication among the components of the device 600. The processor 620 is implemented in hardware, firmware, or a combination of hardware and software. The processor 620 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 620 includes one or more processors capable of being programmed to perform a function.

The memory 630 includes a random access memory (RAM), a read only memory (ROM), and/or another type of dynamic or static storage device (e.g., a flash memory, a magnetic memory, and/or an optical memory) that stores information and/or instructions for use by the processor 620.

The storage component 640 stores information and/or software related to the operation and use of the device 600. For example, the storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 650 includes a component that permits the device 600 to receive information, such as via user input (e.g., a touch screen display, a keyboard, a keypad, a mouse, a button, a switch, and/or a microphone). The input component 650 may include a sensor for sensing information (e.g., a global positioning system (GPS) component, an accelerometer, a gyroscope, and/or an actuator).

The output component 660 includes a component that provides output information from the device 600 (e.g., a display, a speaker, and/or one or more light-emitting diodes (LEDs)).

The communication interface 670 includes a transceiver-like component (e.g., a transceiver and/or a separate receiver and transmitter) that enables the device 600 to communicate with other devices, such as via a wired connection, a wireless connection, or a combination of wired and wireless connections. The communication interface 670 may permit device 600 to receive information from another device and/or provide information to another device. For example, the communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

The device 600 may perform one or more processes described herein. The device 600 may perform operations based on the processor 620 executing software instructions stored by a non-transitory computer-readable medium, such as the memory 630 and/or the storage component 640. A computer-readable medium is defined herein as a non-transitory memory device. A memory device includes memory space within a single physical storage device or memory space spread across multiple physical storage devices.

Software instructions may be read into the memory 630 and/or the storage component 640 from another computer-readable medium or from another device via the communication interface 670. When executed, software instructions stored in the memory 630 and/or storage component 640 may cause the processor 620 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, FPGA, or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
providing a user interface (UI);
receiving a user input to the UI to generate a query;
generating the query based on the user input, wherein the query includes at least one static parameter and at least one dynamic parameter;
retrieving first data from a database based on the query and the at least one dynamic parameter; and
generating a first visualization of the retrieved first data.

2. The method of claim 1, further comprising providing, on the UI, a dynamic parameter changing field configured to receive a dynamic parameter changing user input for changing the at least one dynamic parameter.

3. The method of claim 2, further comprising:
receiving the dynamic parameter changing user input for changing the at least one dynamic parameter; and
changing the at least one dynamic parameter based on the received dynamic parameter changing user input.

4. The method of claim 3, further comprising:
retrieving second data from among the first data based on the query and the changed at least one dynamic parameter; and
generating a second visualization based on the retrieved second data.

5. The method of claim 3, wherein the at least one dynamic parameter is changed without re-generating the query.

6. The method of claim 1, wherein providing the UI comprises providing a list of values as the at least one dynamic parameter.

7. The method of claim 6, further comprising setting the at least one dynamic parameter based on a user selection of the list of values.

8. A system comprising:
a memory storing instructions; and
a processor configured to execute the instructions to:
provide a user interface (UI);
receive a user input to the UI to generate a query;
generate the query based on the user input, wherein the query includes at least one static parameter and at least one dynamic parameter;
retrieve first data from a database based on the query; and
generate a first visualization of the retrieved first data.

9. The system of claim 8, wherein the processor is further configured to execute the instructions to provide, on the UI, a dynamic parameter changing field configured to receive a dynamic parameter changing user input for changing the at least one dynamic parameter.

10. The system of claim 9, wherein the processor is further configured to execute the instructions to:
receive the dynamic parameter changing user input for changing the at least one dynamic parameter; and
change the at least one dynamic parameter based on the received dynamic parameter changing user input.

11. The system of claim 10, wherein the processor is further configured to execute the instructions to:
retrieve second data from among the first data based on the query and the changed at least one dynamic parameter; and
generate a second visualization based on the retrieved second data.

12. The system of claim 10, wherein the at least one dynamic parameter is changed without re-generating the query.

13. The system of claim 8, wherein the processor is further configured to execute the instructions to provide the UI by providing a list of values as the at least one dynamic parameter.

14. The system of claim 13, wherein the processor is further configured to execute the instructions to set the at least one dynamic parameter based on a user selection of the list of values.

15. A non-transitory computer readable storage medium, the storage medium connected to one or more processors and storing instructions that, when executed, cause the one or more processor to:
provide a user interface (UI);
receive a user input to the UI to generate a query;
generate the query based on the user input, wherein the query includes at least one static parameter and at least one dynamic parameter;
retrieve first data from a database based on the query; and
generate a first visualization of the retrieved first data.

16. The storage medium of claim 15, wherein the instructions, when executed, further cause the one or more processors to provide, on the UI, a dynamic parameter changing field configured to receive a dynamic parameter changing user input for changing the at least one dynamic parameter.

17. The storage medium of claim 16, wherein the instructions, when executed, further cause the one or more processors to:
receive the dynamic parameter changing user input for changing the at least one dynamic parameter; and
change the at least one dynamic parameter based on the received dynamic parameter changing user input.

18. The storage medium of claim 17, wherein the instructions, when executed, further cause the one or more processors to:
retrieve second data from among the first data based on the query and the changed at least one dynamic parameter; and
generate a second visualization based on the retrieved second data.

19. The storage medium of claim 17, wherein the at least one dynamic parameter is changed without re-generating the query.

20. The storage medium of claim 15, wherein the instructions, when executed, further cause the one or more processors to provide the UI by providing a list of values as the at least one dynamic parameter.
